(19) United States
(12) Patent Application Publication
(10) Pub. No.: US 2025/0270724 A1
(43) Pub. Date: Aug. 28, 2025

(54) A PROCESS AND APPARATUS FOR PRODUCTION OF ALUMINIUM, AND A PROCESS AND APPARATUS FOR PRODUCTION OF AN ALUMINIUM CHLORIDE CONTAINING FEEDSTOCK

(71) Applicant: Norsk Hydro ASA, Oslo (NO)

(72) Inventors: Christian ROSENKILDE, Porsgrunn (NO); Eirik MANGER, Stathelle (NO); Rawad HIMO, Porsgrunn (NO); Espen Tjønneland WEFRING, Vear (NO)

(73) Assignee: Norsk Hydro ASA, Oslo (NO)

(21) Appl. No.: 18/862,326

(22) PCT Filed: May 5, 2023
(86) PCT No.: PCT/EP2023/061973

§ 371 Date: Nov. 1, 2024

(30) Foreign Application Priority Data
May 5, 2022 (NO) 20220517

(51) Int. Cl. C25C 3/18; C01F 7/60; C01F 7/62; C25C 3/08; C25C 3/22

(52) U.S. Cl. CPC C25C 3/18; C01F 7/60; C01F 7/62; C25C 3/08; C25C 3/22

(57) ABSTRACT

The present invention relates to a process for electrolytic production of aluminium from aluminium chloride, in an electrolysis cell with an electrolyte, where the aluminium chloride is produced by chlorination of an aluminium containing feedstock using chlorine gas and a carbonaceous reducing agent, CO and/or phosgene. The produced aluminium chloride is led to an absorption unit and partly absorbed by a molten salt liquid where some of the molten salt liquid in the absorption unit, enriched with aluminium chloride by the absorption, is transferred to the electrolysis cell wherein the aluminium chloride is electrolytically converted to aluminium metal and chlorine gas. The gases that are not absorbed by the liquid is led out of the absorption unit. The invention also relates to an apparatus for operating the process.

### TECHNICAL FIELD

The present invention relates to a process and an apparatus for production of aluminium. In particular, the invention relates to a process for electrolytic production of aluminium from a feedstock containing aluminium chloride. The present invention also relates to a process and an apparatus for production of an aluminium chloride containing feedstock for electrolytic production of aluminium metal from aluminium chloride. The invention also relates to the method of preparation of the said aluminium chloride containing feedstock including chlorination of an aluminium containing feedstock and passing the produced aluminium chloride gas to an absorbing unit for preparation of a liquid enriched with aluminium chloride, which aluminium chloride enriched liquid can be directly or indirectly transferred to an electrolysis cell unit for electrolytic production of aluminium metal and chlorine gas.

### BACKGROUND

It is known that aluminium chloride can be used as feedstock for electrolytic production of aluminium metal. Such production can be done in an electrolysis cell with at least one anode and one cathode in contact with an electrolyte, e.g. as described in U.S. Pat. No. 4,110,178. For this purpose, the aluminium chloride is added to the electrolyte and electrolyzed to aluminium on the cathode and chlorine on the anode. Several types of electrolytes can be used.

One example is an electrolyte made from low temperature mixtures of aluminium chloride and organic ions (for example Yuguang Zhao and T. J. VanderNoot https://doi.org/10.1016/S0013-4686(96)00271-X). Another example is a molten salt mixture such as described in U.S. Pat. Nos. 4,440,610 and 3,755,099, where a mixture of chlorides of alkali and alkaline earth metals is used, and the electrolysis is performed above the melting point of aluminium (660° C.). According to U.S. Pat. No. 3,755,099, the optimal aluminium chloride concentration in the electrolysis cell is close to 5% aluminium chloride. Feeding solid aluminium chloride to an electrolytic cell at temperatures higher than 660° C. leads to complications due to the large temperature difference between the electrolyte and the sublimation point of the aluminium chloride. At atmospheric pressure aluminium chloride sublimes at about 180° C. The temperature difference can lead to sublimation of the added aluminium chloride before it dissolves in the electrolyte, leading to losses of aluminium chloride. U.S. Pat. No. 4,111,764 describes a means to overcome the sublimation problem. Yet another example is given in U.S. Pat. No. 4,576,690, which describes addition of gaseous aluminium chloride directly to a compartment inside an electrolysis cell. The aluminium chloride is absorbed by the molten salt electrolyte in the cell, while the other gas components following the aluminium chloride are not.

It is known in the art that aluminium chloride can be produced by chlorination of aluminium oxide by reaction with chlorine and a suitable carbon source such as carbon, CO or CH₄ (U.S. Pat. Nos. 3,842,163, 4,957,722). This reaction is best performed at temperatures where the aluminium chloride formed is gaseous (above 150° C.). The other reactions products, CO₂, H₂, etc, are also gaseous. Production of aluminium chloride from aluminium oxide therefore usually includes a step where the gaseous product mixture from the carbochlorination reaction is cooled to a temperature where aluminium chloride condenses and separates from the other components of the gaseous stream. There are several ways to do this, as described in the literature. One example is to use a cooled fluidized bed, as described in U.S. Pat. No. 4,070,488.

### SUMMARY OF THE INVENTION

By the invention, it is achieved simpler and more economic solutions than a fluidized bed and special arrangements to manage aluminium chloride condensation and feeding compared to the described prior art.

The present invention provides an improved method to separate aluminium chloride gas comprised in an aluminium chlorination reaction product gas from a chlorination process. Furthermore, the present invention may simplify the feeding of aluminium chloride to the electrolyte in an electrolysis cell compared to the prior art.

The present invention also represents a solution where CO₂ gas and Cl₂ gas generated in the process may be processed and recycled into the chlorination step of the process, which is of significant importance for reducing the environmental impact of the processing industry.

According to a first aspect, the present invention provides a process for electrolytic production of aluminium from aluminium chloride, aluminium chloride, in an electrolysis cell unit comprising an electrolyte and at least one anode and at least one cathode, wherein the process comprises the following steps,
(a) chlorinating an aluminium containing feedstock by use of chlorine gas and a carbonaceous reducing agent, CO, and/or phosgene, thereby forming a product gas stream comprising aluminium chloride gas, and CO₂ gas;
(b) passing all or a fraction of the product gas stream comprising aluminium chloride gas and CO₂ gas from the chlorination step (a) to an absorption unit, the absorption unit comprises a molten salt liquid, and in which molten salt liquid the aluminium chloride gas is at least partly absorbed and thereby forming a molten salt liquid enriched with aluminium chloride, and wherein the CO₂ gas and any other gaseous components that are not absorbed by the molten salt liquid are led out of the absorption unit and optionally processed in one or more processing unit(s);
(c) transferring, either directly or indirectly, a portion of the molten salt liquid enriched with aluminium chloride from the absorption unit to the electrolyte in the electrolysis cell unit; wherein aluminium chloride is electrolytically converted to aluminium metal and chlorine gas; and
(d) transferring a portion of aluminium chloride lean electrolyte from the electrolysis cell unit, which electrolyte has a lower concentration of aluminium chloride than the molten salt liquid, either directly or indirectly, to the absorption unit thereby replacing some of the molten salt liquid removed from the absorption unit.

By transferring electrolyte from the electrolysis cell to the absorption unit to replace the portion that was transferred from the absorber unit to the electrolysis cell, not counting the aluminium chloride in the salts, the salt components other than aluminium chloride are recycled between the absorption unit and the electrolysis cell.

The aluminium containing feedstock may be an aluminium oxide containing feedstock. The aluminium oxide containing feedstock may be one or more selected from the group comprising; alumina (Al₂O₃), aluminium oxide ore, or aluminium oxide clay mineral. The aluminium oxide ore and aluminium oxide clay are preferably rich in aluminium oxide. Examples of aluminium oxide rich ores and aluminium oxide rich clay minerals are such as bauxite, kaolin, mullite, or aluminium silicate minerals. A feedstock having high content of aluminium oxide may be preferred due to less by-products in the chlorination reaction. If the aluminium containing feedstock comprises other chloride forming metals than aluminium, such as iron, it may be desirable to remove at least some of the other metal chlorides before the product gas is introduced to the absorption unit, e.g. by condensing out chloride.

The carbonaceous reducing agent may be selected from carbon, CO gas, CH₄ gas, CCl₄ gas, and COCl₂, or other carbonaceous reducing agents suitable for a carbochlorination reaction. Carbon may be introduced to the chlorination reactor together with the aluminium containing feedstock, e.g. as a mixture or carbon deposited on the aluminium containing feedstock.

The molten salt liquid in the absorption unit may be a molten salt mixture comprising aluminium chloride, and one or more salt(s) selected from the group; alkali metal chlorides and alkaline earth metal chlorides; and incidental impurities. Any alkali metal chloride may be used, but one or more alkali metal chloride selected from LiCl, NaCl and KCl are preferred. Any alkaline earth metal chloride may be used, but one or more alkaline earth metal chloride selected from MgCl₂ and CaCl₂) are preferred. Advantageously, the molten salt mixture comprises at least two alkali metal chloride salts, and optionally at least one alkaline earth metal chloride salt in addition. Preferably, the molten salt mixture comprises a higher amount of alkali metal chloride salts than alkaline earth metal chlorine salts.

The concentration of aluminium chloride in the molten salt liquid in the absorption unit may be between 45 and 90% by weight, the rest substantially being the said molten salt mixture of alkali metal chloride and/or alkaline earth metal chloride, and any incidental impurities. Incidental impurities may come from the chlorination reaction of the aluminium containing feedstock, which aluminium containing feedstock may comprise metal trace elements. Preferably, the amount of incidental impurities is less than 5% by weight in the molten salt liquid.

The electrolyte in the electrolysis cell unit may be a molten salt mixture comprising aluminium chloride, and one or more salt(s) selected from the group; alkali metal chloride and alkaline earth metal chloride, the one or more salt(s) selected from the group of alkali metal chloride and alkaline earth metal chloride being the same as in the said molten salt liquid in the absorption unit. The electrolyte in the electrolysis cell unit may comprise 0.1-50% by weight aluminium chloride; such as 0.5-20% by weight aluminium chloride; or 1-10% by weight aluminium chloride; or 2-5% by weight aluminium chloride, the rest substantially being the alkali metal chloride and/or alkaline earth metal chloride. By the phrase “the rest substantially being” it should be understood that the composition of the electrolyte is essentially comprised of the above components, however the electrolyte may comprise some incidental impurities. The total amount of incidental impurities should be kept low, correspondingly as the molten salt liquid above. The concentration of aluminium chloride in the electrolyte may depend on cell operation and the properties of the used salt mixture.

To allow for continuous operation of the combined chlorination, absorption and electrolysis units, the compositions of the molten salt in the absorption unit and the electrolyte in the electrolysis cell should preferably be maintained within the limits described above. This can be achieved by transferring the same amount of electrolyte from the electrolysis cell to the absorption unit as was transferred from the absorber unit to the electrolysis cell, not counting the aluminium chloride in the salts. In this way, salt components other than aluminium chloride are recycled between the absorption unit and the electrolysis cell. Therefore, the ratio between the said alkali metal chloride and/or alkaline earth metal chloride salt(s) in the electrolyte composition, exclusive of aluminium chloride, may preferably be within 2 percent by weight of the ratio between the corresponding salt(s) in the molten salt liquid composition in the absorption unit, exclusive of aluminium chloride. By keeping the ratio of the salt mixture components in the molten salt liquid and the electrolyte, exclusive aluminium chloride which will differ, it will be possible to use and transfer the molten salt liquid and the electrolyte between the absorption unit and the electrolysis cell unit without significant disturbance or drift of the process operation.

The concentration of aluminium chloride in the molten salt liquid in the absorption unit should preferably be higher than the concentration of aluminium chloride in the electrolyte in the electrolysis cell unit. The electrolyte is lean of aluminium chloride, thus transferring a portion of the electrolyte from the electrolysis cell unit to the absorption unit leads to efficient absorption of aluminium chloride from the product gas from the chlorination step, and vice versa, the molten salt liquid enriched with aluminium chloride transferred from the absorption unit to the electrolysis cell unit replenish aluminium chloride as it is converted to aluminium metal and chlorine gas.

The portion of molten salt liquid enriched with aluminium chloride may be directly or indirectly transferred from the absorption unit to the electrolysis cell. Direct transfer should be understood to denote continuous or fluid transfer of the materials, e.g. by pumping, from the absorption unit to the electrolysis cell through conduits and/or pipes. The conduits and/or pipes may comprise one or more intermediate mixing volumes. Indirect transfer should be understood to denote transfer of the materials in a semi-continuous or non-fluid manner, involving the use of one or more intermediate volume(s). The portion of aluminium chloride lean electrolyte may correspondingly be directly or indirectly transferred from the electrolysis cell to the absorption unit. Direct transfer should be understood to denote continuous or fluid transfer of the materials, e.g. by pumping, from the electrolysis cell to the absorption unit through conduits or pipes. The conduits and/or pipes may comprise one or more intermediate mixing volumes. Indirect transfer should be understood to denote transfer of the materials in a semi-continuous or non-fluid manner, involving the use of one or more intermediate volume(s).

The one or more intermediate volume(s) may involve a mixing volume. By mixing a portion of the molten salt liquid enriched with aluminium chloride with a portion of aluminium chloride lean electrolyte the temperature of the material in the intermediate volume may be adjusted. E.g. the operation temperature of the electrolysis cell is significantly higher than the temperature of the absorption unit and adjusting the temperature may be advantageous. A single-phase stream from both units may be mixed in one or more mixing volumes operated with rich aluminium chloride e.g. below 200° C., which may allow any solidified salts to dissolve before being pumped again in both directions. One or more intermediate mixing of the two material portions may also adjust the composition of the material to be transferred to the electrolysis cell, thus being more adapted to the conditions in the electrolysis cell, which may lead to a smoother operation of the electrolytic conversion process.

The one or more intermediate volume(s) may involve a step comprising at least partly solidifying the molten salt liquid enriched with aluminium chloride. Solidifying the molten salt liquid enriched with aluminium chloride, alternatively molten salt liquid enriched with aluminium chloride mixed with a portion of aluminium chloride lean electrolyte, enables a semi-continuous or disconnected process. By disconnected it should be understood that the material transfer is not fluid, e.g. by transfer conduits or pipes between the absorption unit and the electrolysis cell. Solidifying the molten salt liquid enriched with aluminium chloride, alternatively a mixture thereof with electrolyte, enables utilization of the feed material to an aluminium chloride electrolysis which may be disconnected from the chlorinating reactor and the absorption unit. It should be understood that the aluminium chloride lean electrolyte may be transferred via the intermediate volume in solid form, or partially solid form. The transfer of molten salt liquid enriched with aluminium chloride from the absorption unit to the electrolysis cell unit via the one or more intermediate volume(s) may thus be performed continuously, semi-continuously or discontinuously.

Furthermore, the process according to the present disclosure may comprise directly or indirectly feeding aluminium chloride lean electrolyte from the electrolysis cell unit to the absorption unit to substantially maintain a predetermined molten salt liquid level and composition in the absorption unit. This step contributes to allowing a continuous process and to maintain high absorption of aluminium chloride from the product gas.

The one or more intermediate volume(s) may involve a mixing volume. By mixing a portion of the aluminium chloride lean electrolyte with a portion of the molten salt liquid enriched with aluminium chloride the temperature of the material in the intermediate volume may be adjusted. E.g. the operation temperature of the electrolysis cell is significantly higher than the temperature of the absorption unit and adjusting the temperature may be advantageous. E.g. the mixing volume(s) may facilitate cooling of the hot aluminium chloride lean electrolyte from the electrolysis cell, which should preferably not be fed directly to the absorption unit as the high temperature could compromise the absorption kinetics. Also, a single-phase stream from both units may be mixed in one or more mixing volumes operated with rich aluminium chloride e.g. below 200° C., allowing any solidified salts to dissolve before being pumped again in both directions. Semi-rich aluminium chloride at temperature e.g. below 200° C. may be continuously pumped to the absorption unit, such as at the top of an absorption tower. Combined with the one or more mixing volume(s), the stream to the absorption unit may be tailored and tuned accurately in both temperature and composition so that maximum absorption from the gas is achieved.

The one or more intermediate volume(s) may involve at least partly solidifying the aluminium chloride lean electrolyte. Solidifying the portion of aluminium chloride lean electrolyte, alternatively portion of aluminium chloride lean electrolyte mixed with a portion of molten salt liquid enriched with aluminium chloride, enables a semi-continuous or disconnected process. By disconnected it should be understood that the material transfer is not fluidly e.g. by transfer conduits or pipes between the electrolysis cell and the absorption unit. Solidifying the aluminium chloride lean electrolyte, alternatively a mixture thereof with molten salt liquid form, enables utilization of the aluminium chloride lean electrolyte feed material to an absorption unit which may be disconnected from the electrolysis cell unit. The transfer of aluminium chloride lean electrolyte from the electrolysis cell unit to the absorption unit via the one or more intermediate volume(s) may thus be performed continuously, semi-continuously or discontinuously.

The portion of the molten salt liquid enriched with aluminium chloride, and/or the portion of the aluminium chloride lean electrolyte, may be directly transferred between the absorption unit and the electrolysis cell unit, via one or more fluid passage(s). The one or more fluid passages may comprise one or more intermediate mixing volume(s). With a direct transfer of the molten salt liquid and the electrolyte there may be a fluid connection, e.g. by use of conduits and/or pipes, between the units, allowing circulation of the molten salt liquid and the electrolyte. By circulating the molten salt liquid and the electrolyte via one of more intermediate volumes, the temperature and composition of the material streams may be adjusted to better adapted to the conditions to the units they are transferred, as explained above.

The absorption of aluminium chloride in the molten salt liquid is exothermic. The temperature in the absorption unit may generally be above the melting temperature of the salt mixture present in the absorption unit, and below 400° C. A suitable operation temperature of the absorption unit may depend on the molten salt composition and chemistry, as well as the product gas composition from the chlorination reactor which may modify the sublimation temperature of aluminium chloride.

Preferably, the temperature of the absorption unit should be such that the equilibrium aluminium chloride vapour pressure over the molten salt is well below the aluminium chloride vapour pressure in the incoming gas mixture to limit the amount of aluminium chloride that leaves the absorption unit together with the gases that are not absorbed. A skilled person in the art would be able to identify suitable working temperature ranges in the absorption unit for different salt composition based on the above-mentioned alkali chloride salts and/or alkaline earth chloride salts. In some embodiments the temperature in the absorption unit will be below 300° C. A temperature below 200° C. may often be preferred as many salt compositions will have a sufficiently wide liquid phase within a suitable compositional range wherein a high concentration of dissolved aluminium chloride may be obtained in the molten salt liquid. The temperature in the absorption unit may be somewhat below the all-liquid temperature of the salt mixture such that there is maintained some solid salt in the absorber, which may maximize the uptake of aluminium chloride from the incoming produced gas. Also, maintaining the temperature in the absorption unit in a relatively low temperature range may lead to less corrosion of the equipment and increased safety of the process. To prevent overheating the molten salt liquid in the absorption chamber, cooling may be required. Cooling of the absorption unit may also be needed in cases where the aluminium chloride lean electrolyte stream into the absorption unit has been solidified prior to addition. Cooling can be achieved by installing cooling devices, for example hollow panels or coils internally cooled by water, steam or other cooling media. It is also possible to cool the surfaces of the absorption unit. The temperature of the absorption unit may be high enough to give a relatively high outgoing temperature of the cooling media, allowing use of the extracted heat for other purposes. At the same time the temperature is sufficiently low to avoid serious material challenges for the absorption unit and cooling devices.

It is desirable that the molten salt liquid from the absorption unit that is to be fed to the electrolysis cell is essentially free from oxygen. Under some conditions, CO₂ may react with aluminium chloride to form CO and alumina: CO₂+AlCl₃=0.5Al₂O₃+CO+1.5Cl₂. This reaction may be effectively suppressed if there is a small amount of a chlorinating agent present. To ensure that the outgoing molten salt liquid from the absorption unit is free from oxygen, the atmosphere in the absorber may contain a small amount of a chlorinating agent. The chlorinating agent may be a mixture of CO and Cl₂, phosgene (COCl₂), carbon tetra chloride, CCl₄, methane, CH₄, carbon and chlorine, or similar.

The process may further comprise collecting and passing the CO₂ gas from the chlorinating step (a) and/or the absorption step (b) to a reactor wherein the CO₂ is decomposed producing CO gas. The CO gas from the conversion is preferably fed to the chlorinating step (a). By collecting the CO₂ gas and converting it to CO, the carbon source can be looped in the process, which is highly desired for environmental reasons. Processes for decomposing CO₂ to form CO and oxygen gas or water are known technology to the skilled person.

Furthermore, the Cl₂ gas formed during the electrolysis of aluminium chloride may be passed from the electrolysis cell unit and collected. The collected Cl₂ gas may be passed to the chlorinating step (a) either directly or via an intermediate tank. Circulating the chlorine gas in the process is beneficial as it reduces the environmental impact of the process and reduces the cost of feed material to the process.

According to an example embodiment of the process for electrolytic production of aluminium from aluminium chloride, aluminium chloride, in an electrolysis cell with an electrolyte, the aluminium chloride is produced by chlorination of an aluminium oxide containing feedstock by use of a chlorine gas and a carbonaceous compound, CO and/or phosgene; all or some of the gas components from the chlorination, including gaseous aluminium chloride, is led to an absorption unit and there at least partly absorbed by a liquid; some of the liquid in the absorption unit, enriched with aluminium chloride by the absorption, is transferred, either directly or indirectly, to the electrolysis cell where the aluminium chloride is electrolytically converted to aluminium metal and chlorine gas, and the gases that are not absorbed by the liquid are led out of the absorption unit. The electrolyte from the electrolysis cell where the aluminium chloride is electrolysed may be fed to the absorption unit to maintain the liquid level in the absorber unit. The electrolyte in the electrolysis cell may contain 0.1 to 50% by weight aluminium chloride and one or more alkali chlorides (up to 99.9% by weight) and one or more alkali earth chlorides (up to 99.9% by weight) and other components including incidental impurities (preferably up to 5% by weight). The amount of aluminium chloride in the electrolyte may be 0.5-20% by weight; such as 1-10% by weight; or 2-5% by weight. Hence, the one or more alkali chlorides may be up to 99.5% by weight; or up to 99% by weight; or up to 98% by weight, and the one or more alkaline earth chlorides in the electrolyte may be up to 99.5% by weight; or up to 99% by weight; or up to 98% by weight. Preferably, the amount of alkali chlorides in the electrolyte is more than the amount of alkaline earth chlorides. The liquid composition, exclusive of aluminium chloride, in the absorption unit may be within 2% by weight of the liquid composition in the electrolysis cell, exclusive of aluminium chloride. The temperature in the absorption unit may be below 200° C. and the aluminium chloride concentration may be above 50% by weight. The atmosphere in the absorption unit may contain a chlorinating agent. The chlorinating agent may be a mixture of chlorine and carbon monoxide, or phosgene, or carbon tetra chloride (CCl₄), or methane or carbon and chlorine.

The process according to the first aspect greatly simplifies the separation of aluminium chloride produced by chlorination of alumina or other aluminium containing feedstock, compared with the traditional methods. The process also eliminates the need for sophisticated feeding devices for solid aluminium chloride to the electrolysis cell that is required if the temperature at the feeding point of aluminium chloride is much higher than the sublimation point of aluminium chloride. Compared to e.g. the absorption described in U.S. Pat. No. 4,576,690, where the gaseous mixture is absorbed in the electrolysis cell itself, the present invention has the advantage that the temperature in the separate absorption unit can be chosen independently of the temperature in the electrolysis cell, which is typically above the melting point of aluminium at 660° C. This allows for much lower temperatures during absorption, leading to the possible use of cheaper materials. It also makes extraction of the heat caused by the exothermic absorption much simpler. It also allows for additional treatment of the product gas, e.g. removal of impurities, before it enters the electrolysis cell.

According to a second aspect, the present invention provides an apparatus for operating the process for electrolytic production of aluminium from aluminium chloride, aluminium chloride, in an electrolysis cell unit comprising an electrolyte and at least one anode and at least one cathode, according to the first aspect described above. The apparatus comprises,
a chlorinating reactor vessel comprising a supply of an aluminium containing feedstock, a supply of a chlorinating gas and a supply of a reducing agent, and an outlet for product gas stream comprising at least aluminium chloride gas and CO₂ gas;
an absorption unit comprising an inlet for receiving all or a fraction of the product gas stream from the chlorinating reactor vessel, the absorption unit containing a molten salt liquid in which gas components of the product gas stream are partly absorbed and thereby forming a molten salt liquid enriched with aluminium chloride, and a gas outlet for extraction of CO₂ gas and any gases not absorbed by the molten salt liquid in the absorption unit; and
one or more transfer means arranged between said absorption unit and an electrolysis cell unit configured for direct or indirect transfer of the molten salt liquid enriched with aluminium chloride from the absorption unit to the electrolysis cell unit, wherein said aluminium chloride is electrolytically converted to aluminium metal and chlorine gas, and for direct or indirect transfer of aluminium chloride lean electrolyte from the electrolysis cell unit (9) to the absorption unit (5, 35, 75).

In an embodiment, the absorption unit may be a bubble column or a vessel comprising means for distribution of the product gas stream in the molten salt liquid. The means for distributing the product gas stream may be a sparger, a mixer or a perforated conduit breaking up the product gas into bubbles which create a large contact area between the product gas and the molten salt liquid.

According to another embodiment, the absorption unit may be a counter-current absorption unit comprising at least an inlet for aluminium chloride lean electrolyte from the electrolysis cell unit and an outlet for molten salt liquid enriched with aluminium chloride, a means, e.g. a pump, which is configured to circulate the molten salt liquid in the counter-current absorption unit, an inlet for the product gas stream, and an outlet for extraction of CO₂ gas and any gases which are not absorbed by the molten salt liquid, wherein the flow direction of the product gas stream is configured opposite the flow direction of the molten salt liquid, such that the inlet of the product gas stream is configured by the outlet for the molten salt liquid enriched with aluminium chloride. The counter-current absorption unit may be horizontally arranged flowing the molten salt liquid in the lower part of the absorption unit, while the gas is passed above the circulating liquid such that aluminium chloride gas is absorbed in the liquid. The gas mixture exiting the counter-current absorption unit is substantially free from aluminium chloride. As the molten salt liquid flows counter-currently to the gas, the liquid becomes enriched in aluminium chloride. Most of the liquid may be recirculated in the absorption unit, but a fraction of the enriched liquid may be extracted close to the gas inlet to be transferred to an electrolysis cell unit.

According to yet another embodiment, the absorption unit may be an absorption tower, comprising one or more inlet(s) for the product gas stream in a lower part of the absorption tower and one or more inlet(s) of aluminium chloride lean electrolyte transferred from an electrolysis cell unit in an upper part of the absorption tower, and furthermore outlet(s) for extraction the CO₂ gas and any other gases not absorbed by the molten salt liquid in the upper part of the absorption tower, and one or more outlet for molten salt liquid enriched with aluminium chloride in the lower part of the absorption tower. The absorption tower may be a tray absorption tower comprising a plurality of trays stacked at a vertical distance from each other. A tray absorption tower may promote gas/bubble breakup which is advantageous to handle large gas volumes. The aluminium chloride lean electrolyte may be intermediately mixed with molten salt liquid enriched with aluminium chloride and adjusted to a temperature below 200° C. The mixed stream may be continuously pumped to the top of the absorption tower above the top tray and the liquid flows downwardly due to gravity. The inlet for the product gas stream may be below the bottom tray. Thus, the aluminium chloride concentration in the molten salt liquid increases in the lower trays before it exits, alternatively exits to the mixing volume. It may be possible to feed alkali metal chloride salt and/or alkaline earth metal chlorine salt, corresponding to the salt mixture comprises in the molten salt mixture and electrolyte, in the top tray to induce a slightly leaner aluminium chloride concentration which may provide a slurry in the very top trays only, to slow down the last small bubbles and improve absorption efficiency. The trays should be reasonably shallow and well agitated by the gas bubbles so the slurry mixture becomes well mixed without any phase separation. The molten salt liquid at the lower trays should preferably be pure liquid phase as they will have a higher aluminium chloride concentration due to absorption therein.

The absorption unit may also use a scrubber configuration, where the product gas is fed to a scrubber and absorbed by a falling molten salt liquid.

The said transfer means, which may be configured for indirect transfer of molten salt liquid enriched with aluminium chloride and/or aluminium chloride lean electrolyte, may comprise one or more intermediate volume(s), which intermediate volume(s) may be configured to intermediately mix molten salt liquid enriched with aluminium chloride and aluminium chloride lean electrolyte, and/or to adjust the temperature of the molten salt liquid enriched with aluminium chloride and/or aluminium chloride lean electrolyte before being transferred to the receiving unit.

The one or more intermediate volume(s) may be configured to partly or fully solidify the molten salt liquid enriched with aluminium chloride, or the aluminium chloride lean electrolyte, or a mixture thereof. A solidified molten salt liquid enriched with aluminium chloride may be transferred and utilized in an electrolysis cell for electrolytic conversion of aluminium chloride, which is not directly and fluidly connected with the absorption unit. Equally, solidifying an aluminium chloride lean electrolyte enables transfer of such electrolyte to an absorption unit which is not directly and fluidly connected with the electrolysis unit.

Alternatively, the transfer means may be configured for direct transfer of molten salt liquid enriched with aluminium chloride and/or aluminium chloride lean electrolyte, wherein the transfer means may comprise conduits and/or pipes fluidly connecting the absorption unit and the electrolysis cell unit, preferably via one or more intermediate volume(s) configured to intermediately mix a stream of molten salt liquid enriched with aluminium chloride and a stream of aluminium chloride lean electrolyte, and optionally to adjust the temperature of the obtained mix.

The transfer means for transferring aluminium chloride lean electrolyte from the electrolysis cell unit to the absorption unit may be configured to intermediately mix the aluminium chloride lean electrolyte with a stream of molten salt liquid enriched with aluminium chloride in one or more mixing volume(s) to form a liquid single-phase transfer stream to the absorption unit.

The chlorine gas formed in the electrolysis cell unit may be extracted from the electrolysis cell unit via an outlet and returned to the chlorination reactor vessel. The chlorine gas may be recycled to the chlorination reactor vessel via an intermediate Cl₂ tank. Returning the chlorine gas to the chlorination reactor vessel is beneficial as it recycles the chlorine into the process, thus eliminating need for handling the chlorine gas providing a cost-efficient process.

The apparatus may further comprise means for collecting and passing the CO₂ gas from the chlorination reactor vessel and/or the absorption unit to a reactor in which reactor the CO₂ gas is processed and converted into CO gas. The conversion of CO₂ gas may also produce oxygen gas. Other CO₂ conversion processes forming CO gas may also be realized. The formed CO gas may preferably be recycled to the chlorination reaction vessel.

In an example embodiment, the apparatus for operating the process according to the first embodiment, comprises; a chlorinating reactor vessel which may be provided with supply of an aluminium oxide containing feedstock, a supply of a chlorine gas and a carbonaceous compound, CO and/or phosgene; an absorption unit receiving all or some of the gas components from the chlorination, including gaseous aluminium chloride, where said gas components are partly absorbed by a liquid present in the absorption unit, where the liquid in the absorption unit becomes enriched with aluminium chloride by absorption; conduits which may be arranged between said absorption unit and an electrolysis cell for transfer of aluminium chloride produced by chlorination to the electrolysis cell, where the electrolysis cell converts said aluminium chloride electrolytically to aluminium metal and chlorine gas; and where gases that are not absorbed by the liquid in the absorption unit is led out of the absorption unit. The chlorine gas from the electrolysis cell may be returned to the chlorination reactor vessel. aluminium chloride lean liquid may be returned from the electrolysis cell to the absorption unit. CO₂ gas from the chlorination reactor vessel may be captured and processed in a reactor that transforms CO₂ into CO and O₂. The said CO may be fed to the chlorination reaction vessel.

According to a third aspect, the present invention provides process for producing an aluminium chloride comprising feedstock for electrolytic production of aluminium from aluminium chloride, aluminium chloride, in an electrolysis cell with a molten salt electrolyte, the method comprises the following steps,
(a) chlorinating an aluminium containing feedstock by reacting with chlorine gas and a carbonaceous reducing agent, CO and/or phosgene, forming a product gas stream comprising aluminium chloride gas, CO₂ gas and any unreacted reactants and incidental impurities:
(b) passing all or a fraction of the product gas stream comprising at least aluminium chloride gas and CO₂ gas from the chlorination step (a) to an absorption unit, the absorption unit containing a molten salt liquid, and in which molten salt liquid the aluminium chloride gas is at least partly absorbed and thereby forming a molten salt liquid enriched with aluminium chloride, and wherein the CO₂ gas and any other gaseous components that are not absorbed by the molten salt liquid are led out of the absorption unit and optionally processed in one or more processing unit(s).

The aluminium containing feedstock may be an aluminium oxide containing feedstock. The aluminium oxide containing feedstock may be one or more selected from the group comprising; alumina (Al₂O₃), aluminium oxide ore, or aluminium oxide clay mineral. The aluminium oxide ore and aluminium oxide clay are preferably rich in aluminium oxide. Examples of aluminium oxide rich ores aluminium oxide rich clay minerals are such as bauxite, kaolin, mullite, or aluminium silicate minerals. A feedstock having high content of aluminium oxide may be preferred due to less by-products in the chlorination reaction. If the aluminium containing feedstock comprises other chloride forming metals than aluminium, such as iron, it may be desirable to remove at least some of the other metal chlorides before the product gas is introduced to the absorption unit, e.g. by condensing out chloride.

The carbonaceous reducing agent may be selected from carbon, CO gas, CH₄ gas, CCl₄ gas, and COCl₂. Carbon may be introduced to the chlorination reactor together with the aluminium containing feedstock, e.g. as a mixture or carbon deposited on the aluminium containing feedstock.

The molten salt liquid in the absorption unit may be a molten salt mixture comprising aluminium chloride, and one or more salt(s) selected from the group; alkali metal chloride and alkaline earth metal chloride; and incidental impurities. Any alkali metal chloride may be used, but one or more alkali metal chloride selected from LiCl, NaCl and KCl are preferred. Any alkaline earth metal chloride may be used, but the one or more alkaline earth metal chloride selected from MgCl₂ and CaCl₂) are preferred. Advantageously, the molten salt mixture comprises at least two alkali metal chloride salts, and optionally at least one alkali metal chloride salt. Preferably, the molten salt mixture comprises a higher amount of alkali metal chloride salts than alkaline earth metal chlorine salts.

The concentration of aluminium chloride in the molten salt liquid in the absorption unit may be between 45 and 90% by weight, the rest substantially being the said molten salt mixture of alkali metal chloride and/or alkaline earth metal chloride, and any incidental impurities. Incidental impurities may come from the chlorination reaction of the aluminium containing feedstock, which aluminium containing feedstock may comprise metal trace elements. Preferably, the amount of incidental impurities is less than 5% by weight in the molten salt liquid.

The composition of the molten salt liquid, exclusive aluminium chloride may correspond to the composition of the molten salt electrolyte, to which the aluminium chloride containing feedstock is to be added. The ratio between alkali metal chloride and/or alkaline earth metal chloride salt(s) in the molten salt electrolyte composition, exclusive of aluminium chloride, may be within 2 percent by weight of the ratio between the corresponding salt(s) in the molten salt liquid composition in the absorption unit, exclusive of aluminium chloride. By keeping the ratio of the salt components in the molten salt liquid and the molten salt electrolyte, exclusive aluminium chloride, the feedstock may be added to the electrolysis cell without significant disturbance or drift of the operation of the electrolysis process.

Molten salt electrolyte lean in aluminium chloride may be transferred to the absorption unit, thereby replacing any aluminium chloride rich molten salt liquid being transferred to the electrolysis cess and diluting the concentration of aluminium chloride in the molten salt liquid contained in the absorption unit to maintain a high absorption of aluminium chloride from the product gas. The transfer of molten salt liquid enriched with aluminium chloride and/or molten salt electrolyte lean in aluminium chloride may be performed via intermediate volumes. The intermediate volumes may include solidified materials, mixing of volumes and/or adjustment of temperature of the materials to be transferred, for the same reasons as explained above.

The absorption of gaseous aluminium chloride in the molten salt liquid is exothermic. The temperature in the absorption unit may in general be above the melting temperature of the salt mixture present in the absorption unit, and below 400° C. A suitable operation temperature of the absorption unit may depend on the molten salt composition and chemistry, as well as the product gas composition. Preferably, the temperature of the absorption unit should be such that the equilibrium aluminium chloride vapour pressure over the molten salt is well below the aluminium chloride vapour pressure in the incoming gas mixture to limit the amount of aluminium chloride that leaves the absorption unit together with the gases that are not absorbed. A skilled person in the art will be able to identify suitable working temperature ranges in the absorption unit for different salt composition based on the above-mentioned alkali chloride salts and/or alkaline earth chloride salts. In some embodiments the temperature in the absorption unit will be below 300° C. A temperature below 200° C. may often be preferred as many salt compositions will have a sufficiently wide liquid phase within a suitable compositional range wherein a high concentration of dissolved aluminium chloride may be obtained in the molten salt liquid. The temperature in the absorption unit may be somewhat below the all-liquid temperature of the salt mixture such that there is maintained some solid salt in the absorber, which may maximize the uptake of aluminium chloride from the incoming produced gas. Also, maintaining the temperature in the absorption unit at a relative lower temperature range may lead to less corrosion of the equipment and increased safety of the process. Cooling of the absorption unit may also be needed in cases where the aluminium chloride lean electrolyte stream into the absorption unit has been solidified prior to addition. Cooling can be achieved by installing cooling devices, for example hollow panels or coils internally cooled by water, steam or other cooling media. It is also possible to cool the surfaces of the absorption unit. The temperature of the absorption unit may be high enough to give a relatively high outgoing temperature of the cooling media, allowing use of the extracted heat for other purposes. At the same time the temperature is sufficiently low to avoid serious material challenges for the absorption unit and cooling devices.

It is desirable that the molten salt liquid from the absorption unit to be fed to an electrolysis cell is nearly completely free from oxygen. Under some conditions, CO₂ may react with aluminium chloride to form CO and alumina: CO₂+AlCl₃=0.5Al₂O₃+CO+1.5Cl₂. This reaction may be effectively suppressed if there is a small amount of a chlorinating agent present. To ensure that the outgoing molten salt liquid from the absorber is free from oxygen, the atmosphere in the absorber may contain a small amount of a chlorinating agent. The chlorinating agent may be a mixture of CO and Cl₂, phosgene (COCl₂), carbon tetra chloride, CCl₄, methane, CH₄, carbon and chlorine, or similar.

The process may preferably further comprise collecting and passing the CO₂ gas from the chlorinating step (a) and/or the absorption step (b) to a reactor wherein the CO₂ is decomposed producing CO gas. The CO gas from the conversion is preferably fed to the chlorinating step (a). By collecting the CO₂ gas and converting it to CO, the carbon source can be looped in the process, which is highly desired for environmental reasons. Processes for decomposing CO₂ to form CO and oxygen gas or other CO₂ gas decomposition producing CO gas are known technology.

According to a fourth aspect, the invention provides an apparatus for producing an aluminium chloride containing feedstock for electrolytic production of aluminium from aluminium chloride, aluminium chloride, in an electrolysis cell with a molten salt electrolyte, the apparatus comprising
a chlorinating reactor vessel comprising a supply of an aluminium containing feedstock, a supply of a chlorinating gas and a supply of a reducing agent, and an outlet for product gas stream comprising at least aluminium chloride gas, CO₂ gas,
an absorption unit comprising an inlet for receiving all or a fraction of the product gas stream from the chlorinating reactor vessel, the absorption unit containing a molten salt liquid in which gas components of the product gas stream are partly absorbed and thereby forming a molten salt liquid enriched with aluminium chloride, and a gas outlet for extraction of CO₂ gas and any gases not absorbed by the molten salt liquid in the absorption unit, and
means for transferring the molten salt liquid enriched with aluminium chloride to an electrolysis cell via one or more intermediate volumes.

The absorption unit may be of the same type as described above for any of the embodiments of the apparatus according to the second of the present invention.

The apparatus may further comprise means for collecting and passing the CO₂ gas from the chlorination reactor vessel and/or the absorption unit to a reactor in which reactor the CO₂ gas is processed and converted into CO gas. The conversion of CO₂ gas may also produce oxygen gas. Other CO₂ conversion processes forming CO gas may also be realized. The formed CO gas may preferably be recycled to the chlorination reaction vessel.

It should be understood that the above disclosed processes may include more than one chlorinating reactor, absorption unit and electrolysis cell unit. The number of the said units is independent from each other, e.g. the product gas stream from one chlorinating reactor may be passed to two or more absorption units, or product gas stream from more than one chlorinating reactors may be passed to one absorption unit, etc. The number of electrolysis cell units may also be adapted based on the capacity of the electrolysis cells compared with the amount of aluminium chloride feedstock produced. Correspondingly, the above disclosed apparatuses may comprise different number of each unit; chlorinating reactor vessel, absorption unit and electrolysis cell.

### BRIEF DESCRIPTION OF DRAWINGS

Following drawings are appended to facilitate the understanding of the invention. The drawings show embodiments of the invention, which will now be described by way of example only, where:

FIG. 1a-b disclose phase diagrams for the NaCl—KCl—AlCl₃ system at 150° C. and 170° C., respectively.

FIG. 2 discloses a phase diagram for the NaCl—KCl—AlCl₃ system at equimolar NaCl—KCl composition and varying AlCl₃ concentration.

FIG. 3a-b illustrates a schematic drawing of a combined chlorination, absorption and electrolysis process and apparatuses, and material flow between the illustrated units. The option to reduce the CO₂ from the absorber to CO and return the CO to the carbochlorination reactor according is indicated by dotted line.

FIG. 4 illustrates the material streams according to the illustrating example on the present disclosure.

FIG. 5a-b illustrates one possible arrangement of the absorption unit where the incoming gas is passed above the electrolyte or liquid contained in a counter-current circulating absorption unit, FIG. 5a is a top view and 5b is a side view.

FIG. 6a-b discloses another possible arrangement of the absorption unit where the incoming gas is bubbled through the molten salt liquid contained in the absorption unit, where 6a is a side view and 6b is an end view of the absorption unit.

FIG. 7 illustrates an embodiment wherein the absorption unit is a counter current tray absorption tower.

FIG. 8 illustrates a schematic drawing of a combined chlorination and absorption process and apparatuses, and material flow between the illustrated units. The option to reduce the CO₂ from the absorber to CO and return the CO to the carbochlorination reactor according is indicated by dotted line.

### DETAILED DESCRIPTION

In the following, embodiments of the invention will be discussed in more detail with reference to the appended drawings. It should be understood, however, that the drawings and the detailed description are not intended to limit the invention to the subject-matter depicted in the drawings as the drawings and the description thereof are intended to give illustrating examples to ease the understanding of the present invention for the skilled reader.

In the present disclosure the term “aluminium chloride” refers to anhydrous form of aluminium chloride and the term should be understood to include the monomer form AlCl₃ and the dimer form Al₂Cl₆ which may coexist and both in molten state and in gaseous state. The term “AlCl₃” used herein may also include the dimer form Al₂Cl₆,

In the present disclosure “liquid” and “molten salt liquid” generally refers to the liquid comprised in the absorption unit, in which gaseous aluminium chloride is absorbed, as well as the molten salt liquid enriched with aluminium chloride which may be transferred to the electrolysis cell as an aluminium chloride feedstock to replenish aluminium chloride as it is consumed in the electrolysis cell. The term “electrolyte” generally refers to the molten salt electrolyte comprised in the electrolysis cell, and the aluminium chloride lean electrolyte which may be transferred to the absorption unit.

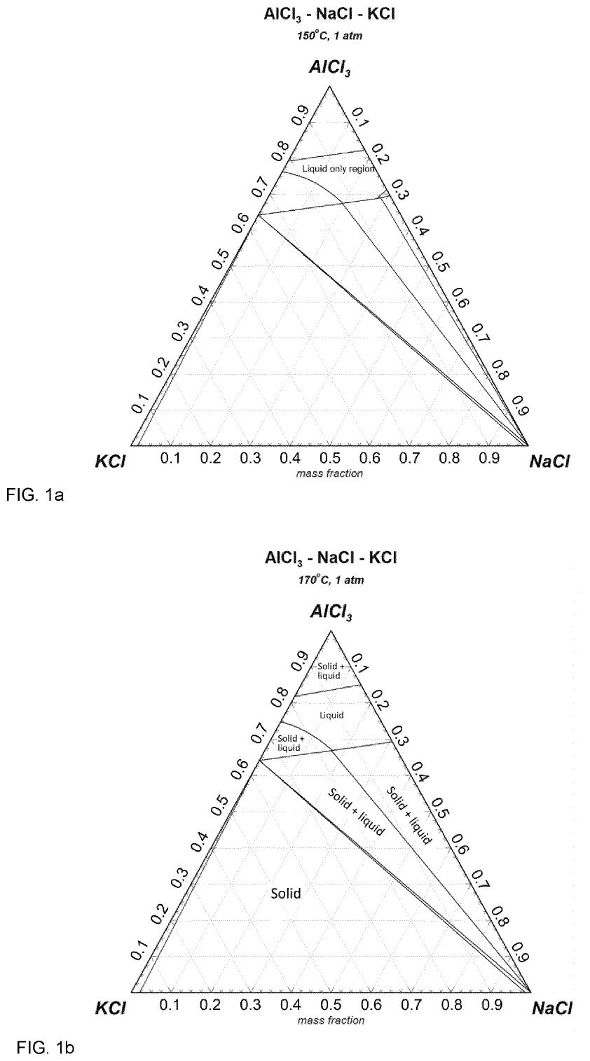

Mixtures of alkali metal chlorides and aluminium chloride may be completely molten down to temperatures as low as about 100° C. at relatively high aluminium chloride concentrations. This is illustrated in a phase diagram for the NaCl—KCl—AlCl₃ system, ref. FIGS. 1a and b showing the ternary NaCl—KCl—AlCl₃ system at 150° C., 1 atm. and 170° C., 1 atm., respectively. FIG. 1a shows that there is a relatively large fully liquid region in the NaCl—KCl—AlCl₃ mixture at 150° C. when the mixture is rich in aluminium chloride. FIG. 1b shows that the fully liquid region is even larger at 170° C. Other alkali metal chlorides, e.g. mixtures containing LiCl, and alkaline earth metal chlorides salt bath dissolve aluminium chloride, and may show a similar phase diagram, having a fully liquid region at relatively low temperatures.

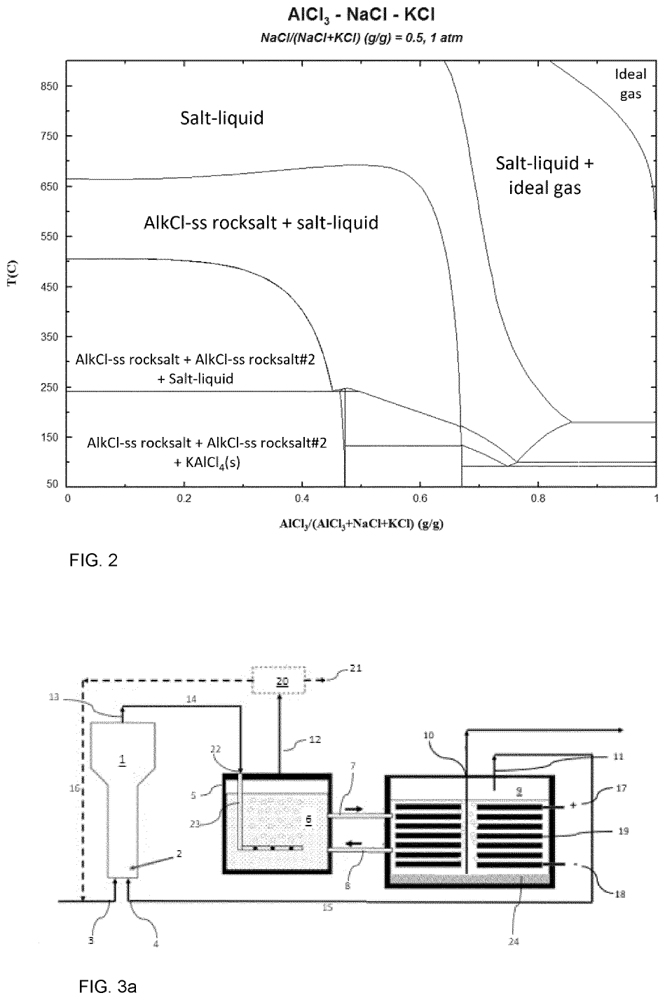

FIG. 2 shows a phase diagram for the NaCl—KCl—AlCl₃ system at equimolar NaCl—KCl composition and varying aluminium chloride concentration at 1 atm. It shows that the temperature of the all-liquid region (Salt-liquid) rises steeply when the aluminium chloride concentration drops below a certain limit. It also shows that the vapour pressure of aluminium chloride (gas-ideal) increases with both temperature and aluminium chloride concentration. A liquid region of molten salt exists above 170° C. at aluminium chloride concentrations between about 65 and 85 weight % aluminium chloride. At this temperature aluminium chloride will be predominantly in the dimer form Al₂Cl₆, however generally denoted aluminium chloride for simplicity. The phase diagram in FIG. 2 also shows that the partial pressure of aluminium chloride is below 1 atmosphere at 170° C. It is therefore possible to use a molten salt mixture in this composition range to absorb gaseous aluminium chloride at temperatures as low as 150° C. Gaseous aluminium chloride will dissolve in the molten salt mixture. It should be noted that these properties of dissolving aluminium chloride gas are not unique for the AlCl₃—NaCl—KCl system. The properties of low melting point temperature at relatively high aluminium chloride concentration is shared for many mixtures formed by combinations of alkali metal chlorides and alkaline earth metal chlorides. The ability of these molten salt mixtures to absorb aluminium chloride forms an important part of the current invention, as it provides a simplified process to separate the aluminium chloride formed in the chlorination step from the other gaseous components. In addition, these molten salts may also be used in the electrolysis cell for electrolytically conversion of the aluminium chloride to aluminium metal and chlorine gas, thus both molten salt mixtures (the absorption liquid and the electrolyte) may have a corresponding base composition and may be transferred between the absorption unit and the electrolysis cell.

The process comprises a step for producing aluminium chloride gas by chlorination of an aluminium containing feedstock. The aluminium containing feedstock is preferably an aluminium oxide (Al₂O₃) containing feedstock. The aluminium oxide containing feedstock may be one or more selected from the group comprising; alumina (Al₂O₃), aluminium oxide rich ore, or aluminium oxide rich clay mineral. Examples of aluminium oxide rich ores and aluminium oxide rich clay minerals are such as bauxite, kaolin, mullite, or aluminium silicate minerals. A feedstock having high content of aluminium oxide may be preferred as it produces less by-products in the chlorination reaction.

The chlorination is preferably a carbochlorination reaction where gaseous aluminium chloride is produced by reacting the aluminium in the aluminium containing feedstock with chlorine gas and a carbonaceous reducing agent. The carbonaceous reducing agent may be selected from carbon, CO gas, CH₄ gas, CCl₄ gas, and COCl₂. Other carbon containing reducing agents generally known in the field for carbochlorination of aluminium may also be used. Phosgene (COCl₂) may be used alone to chlorinate aluminium containing feedstock. Carbon may be introduced to the chlorination reactor together with the aluminium containing feedstock, e.g. as a mixture or carbon deposited on the aluminium containing feedstock. In a preferred method, the carbochlorination for producing aluminium chloride may be performed by reacting Al₂O₃ with CO gas and Cl₂ gas according to the reaction,

Al₂O₃(s)+3CO(g)+3Cl₂(g)=2AlCl₃(g)+3CO₂(g) (I)

The carbochlorination reaction (I) may be performed at a temperature of 400-1200° C. in a chlorination reactor, such as a carbochlorination reactor. The carbochlorination reaction may be performed according to generally known processes. The chlorination reactor may have an inlet for the aluminium oxide containing feedstock, an inlet for carbonaceous reducing agent, CO and/or phosgene, and an inlet for chlorine gas. The aluminium oxide (Al₂O₃) containing feedstock may be comprised in a fluid bed, a fixed bed or any other type of installation which allow readily contact between the gases and the solid aluminium oxide containing particles. The carbochlorination reactor further comprises an outlet for the produced aluminium chloride gas and CO₂ gas and any unreacted process gases and by-product gases. The outgoing gas stream of the carbochlorination reactor, herein also denoted product gas stream, is mainly comprising a gaseous mixture of aluminium chloride and CO₂. Its temperature is similar to the reactor temperature, more typically about 700° C.

The outgoing product gas stream from the chlorination reactor is passed in its entirety or a fraction thereof to an absorption unit (the absorption unit may also be denoted absorber in the present disclosure). The gas mixture condensation temperature increases with the concentration of aluminium chloride and the pressure, which may dictate the lower limits of the temperature of the product gas stream going into the absorption unit. The absorption unit comprises a molten salt liquid, in which liquid the aluminium chloride is at least partly absorbed and thereby forming a molten salt liquid enriched with aluminium chloride. The gaseous components of the product gas stream that are not absorbed by the liquid, mainly CO₂, are led out of the absorption unit via an outlet. The outgoing gaseous stream has a much lower aluminium chloride concentration than the ingoing gaseous stream, preferably, the outgoing gaseous stream has essentially no aluminium chloride.

There may also be another solid or liquid ingoing stream to the absorption unit, based on the electrolyte coming from the electrolysis cell. If this ingoing stream is solid or partly solid, the solid shall fully or partly dissolve in the molten salt liquid contained in the absorption unit. There will generally also be an outgoing liquid stream, which will have a higher aluminium chloride concentration than the ingoing solid or liquid stream. The outgoing liquid stream having a higher aluminium chloride concentration may be transferred via one or more volumes which may comprise a solidified stream.

The liquid comprised in the absorbing unit is preferably a molten salt mixture of alkali metal chlorides and alkaline earth metal chlorides. The molten salt liquid in the absorbing unit may comprise additional components which may be regarded as impurities, e.g. form the chlorinating process. In a preferred embodiment, the liquid comprised in the absorbing unit is a molten salt mixture with aluminium chloride concentration of between 45 to 90% by weight. Preferably the molten salt mixture has a aluminium chloride concentration of between 50 to 86% by weight, or from 65 to 80% by weight;

balance may preferably be a mix of alkali metal chlorides and alkaline earth metal chlorides, e.g. with a ratio of 40-60% NaCl and 40-60% KCl, such as 50/50% NaCl/KCl. LiCl may partly replace NaCl or KCl. Other alkali metal chlorides and alkaline earth metal chlorides can be added to adjust vapor pressure and melting temperature of the absorber liquid. The molten salt liquid can be maintained in a fully liquid phase at a temperature slightly higher than (or possibly even lower than) the sublimation temperature of the product gas inlet stream (mainly comprising aluminium chloride and CO₂) thereby improving the kinetics of aluminium chloride absorption at low temperatures. By the absorption of aluminium chloride into the molten salt liquid a molten salt liquid enriched with aluminium chloride is obtained, which liquid can be used as feed to the electrolysis cell for electrolytically converting the aluminium chloride to aluminium metal and chlorine gas.

The outgoing gaseous stream mainly comprising CO₂ is preferably led to a reactor wherein the CO₂ is converted to produce CO gas which may be recycled to the chlorinating reactor. The outgoing gaseous stream mainly comprising CO₂ may be preconditioned to remove unwanted impurity components before being led to the reactor for the conversion into CO gas.

Some of the liquid enriched with aluminium chloride from the absorption unit may be transferred, either directly or indirectly via one or several separate volumes, e.g. mixing volumes, to the electrolyte in the electrolysis cell unit. The inflow of molten salt liquid enriched with aluminium chloride into the electrolysis cell may be adjusted to maintain a desired concentration of aluminium chloride in the electrolyte in the electrolysis cell. A desired concentration of aluminium chloride in the electrolysis cell is 0.1-50% by weight, such as 0.5-20% by weight; or preferably between 1 to 10% by weight. In many electrolysis cells the concentration of aluminium chloride in the electrolyte should be in the range of 2-5% by weight. The aluminium chloride is electrolytically converted to aluminium metal and chlorine gas in the electrolysis cell, according to generally known processes.

The electrolyte being depleted of aluminium chloride in the electrolysis cell may be partially returned, directly or indirectly via one or several volumes, e.g. mixing volumes, to the absorption unit to be enriched with new aluminium chloride coming from the carbochlorination reactor.

### DETAILED DESCRIPTION OF THE DRAWINGS

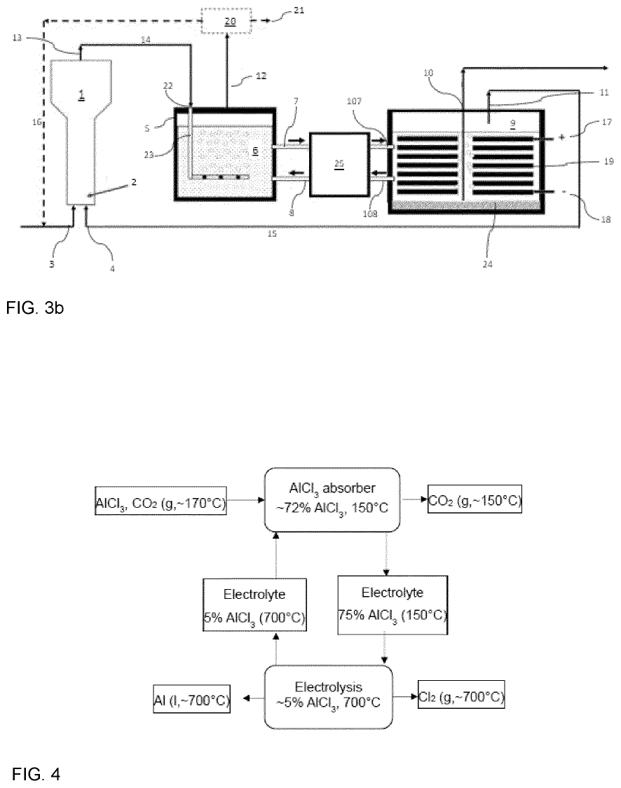

FIG. 3a illustrates the main material flows and operational units in an embodiment of an apparatus suitable for operating the process according to the present disclosure. The apparatus comprises a chlorinating reactor 1, comprising an inlet 2 for an aluminium containing feedstock, an inlet 3 for carbonaceous reducing agent, and an inlet for chlorine gas 4. The chlorinating reactor further comprises an outlet 13 for the chlorination product gas stream 14, which product gas stream 14 is passed to an inlet 22 of an absorption unit 5. The absorption unit comprises means 23 for distributing the product gas stream 14 into a molten salt liquid 6 contained in the absorption unit 5. The absorption unit has an outlet for any gaseous components 12, mainly CO₂, that are not absorbed in the molten salt liquid 6. The gas stream 12 may be led to a reactor 20 for conversion of the CO₂ to CO and oxygen gas 21. The CO gas may be returned by line 16 to the chlorination reactor. The absorption unit 5 and the electrolysis cell 9 may be connected by two transfer conduits 7 and 8. The conduit 7 may transfer molten salt liquid enriched with aluminium chloride to the electrolysis cell unit 9, and the conduit 8 may transfer aluminium chloride lean electrolyte to the absorption unit. The electrolysis unit comprises an anode 17 and a cathode 18 and stacked between the anode and the cathode there are several bipolar electrodes 19. The aluminium metal 24 which is electrolytically formed in the electrolysis cell 9 accumulates in the bottom in the electrolysis cell 9 and may be drained from the electrolysis cell via a suction line 10. Chlorine gas which is also produced in the electrolysis cell is led out via outlet 11 and may be returned to the chlorination reactor 1 via line 15. The chlorine gas may be returned to the chlorinating reactor via an intermediate tank, not shown in the drawings.

FIG. 3b generally illustrates the same apparatus as in FIG. 3a, except there is an intermediate volume 25 between the absorption unit and the electrolysis cell. Although only one shown, the intermediate volume 25 may consist of more than one volume, and may be separate for each transfer lines 7, 107 and 8, 108. The intermediate volume 25 may also be interrupting the transfer lines by not being fluidly connected to both the absorption unit 5 and the electrolysis unit 9.

FIG. 5a-b illustrates a possible absorber unit 35 arrangement where the absorbing molten salt liquid mixture circulates in a horizontal pipe. The liquid level in the pipe is allowing for a gas volume in the upper part of the pipe. Liquid circulation is maintained by a suitable pump 30. The pump 30 and its inlet are arranged in such a way that there is nearly no gas passing through the pump. The aluminium chloride gas mixture 32 is fed at one point and passed counter current to the liquid flow 31. The gas passes through the pipe and exits 33 at the other end. While passing over the liquid, the aluminium chloride gas is absorbed. The gas mixture exiting 33 the pipe is therefore nearly free from aluminium chloride and contains mainly the other gas components of the incoming gas. As the liquid flows counter current to the gas, it is enriched in aluminium chloride. Most of the liquid is recirculated, but a fraction of the enriched liquid is extracted 34 close to the gas inlet 32. This fraction 34 can be fed to the electrolysis cell 9 in order to supply aluminium chloride to the electrolysis cell. Close to the gas outlet 33 of the pipe, electrolyte from the electrolysis cell is fed 36 to the circulating liquid salt. The aluminium chloride concentration in the electrolyte added 36 is lower than in the circulating liquid. The electrolyte may be fed as a solid or a liquid. The heat evolved during the absorption of the aluminium chloride may be extracted in several ways. The pipe may be jacketed (not shown), and a suitable coolant used in the jacket. The jacket can also be used to establish and maintain the correct temperature along the pipe. It is also possible to vary the temperature along the pipe. The pipe may be chosen from a large range of materials, for example metals, ceramics, glasses and polymers.

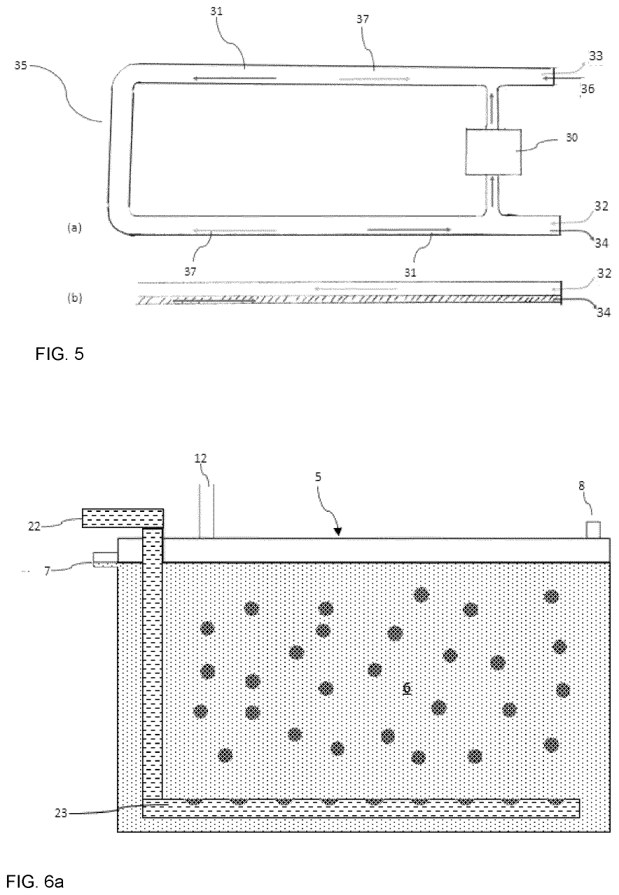

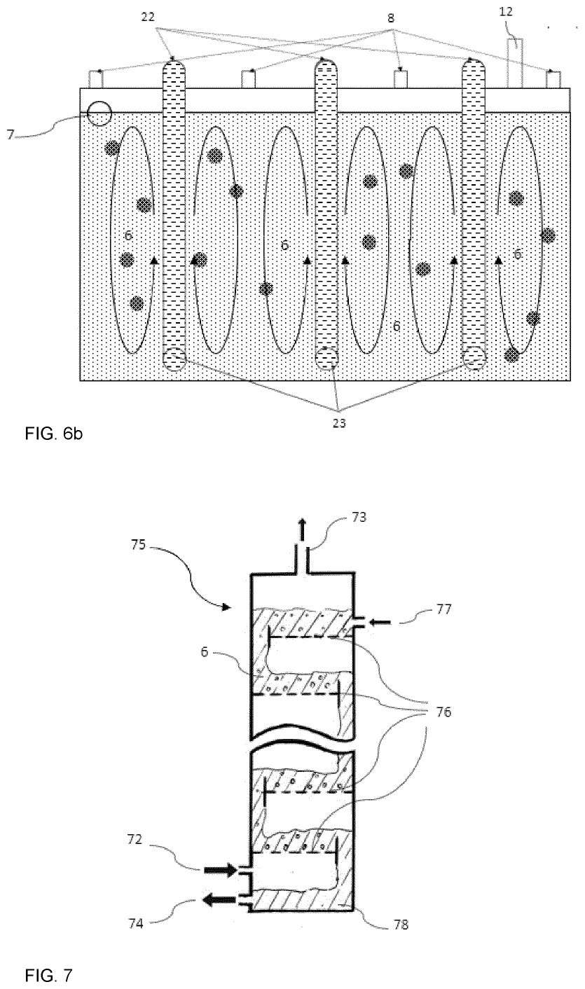

FIG. 6 a (side view) and 6b (end view) show another possible absorber unit 5 arrangement where the gas mixture is fed 22 to a vessel through perforated pipes 23 in the bottom of the vessel. Several pipes 22, 23 may be used. The pipes are arranged in a way to create a certain flow of the molten salt liquid 6. Directly above each perforated pipe 23 where the gas exits, the rising bubbles will create an upwards liquid flow. Between the pipes there will be a downward flow. The aluminium chloride in the gas will be absorbed by the liquid 6 as it rises to the surface. The gas bubbles released at the surface will be nearly free from aluminium chloride. The gas exits the vessel through one or more suitable points 12. Some of the molten salt liquid enriched with aluminium chloride is continuously or semi-continuously extracted at one or more points 7. This outlet point 7 may be arranged as an overflow, a suction point, a pumping point or a point below the liquid surface equipped with a suitable valve. The extracted molten salt liquid enriched with aluminium chloride can be used as feed to the electrolysis cell to supply aluminium chloride. At another point or points 8, preferably at some distance from the molten salt liquid outlet point 7, electrolyte from the electrolysis cell is added, either as a liquid or a solid. Stirring of the liquid in the vessel ensured by the rising bubbles that provide effective mixing of the molten salt liquid 6. It is possible to extract the heat evolved during the absorption of the aluminium chloride for example by suitable panels or coils (not shown), either as separate units in the vessel or integrated in the vessel walls. The vessel materials may be chosen from a large range of materials, for example metals, ceramics, glass and polymers.

FIG. 7 illustrates a third possible absorption unit 75, where the absorption unit is based on a tray absorption tower. The product gas mixture is fed via an inlet 72 in the lower part of the absorption tower below the bottom tray 76. Electrolyte lean in aluminium chloride from the electrolysis cell is fed via an inlet 77 to the top tray 76. The electrolyte flows down due to gravity via several trays 76 counter-currently to the upward flow direction of the product gas mixture. The aluminium chloride in the gas will be absorbed by the liquid 6 as it travels upwardly in the absorption tower, before being led out through an outlet 73 by the top of the absorption tower. As the liquid flows down the absorption tower it becomes enriched with aluminium chloride. The molten salt liquid enriched with aluminium chloride 78 can be extracted via outlet 74 at the lower part of the absorption tower, and transported further downstream in the process, either directly or indirectly, via one or several mixing volumes, to the electrolysis cell. Absorption towers can generally handle large gas volumes, improve distribution, and promote gas/bubble breakup. Suitable construction materials are metals, ceramics, glass and polymers.

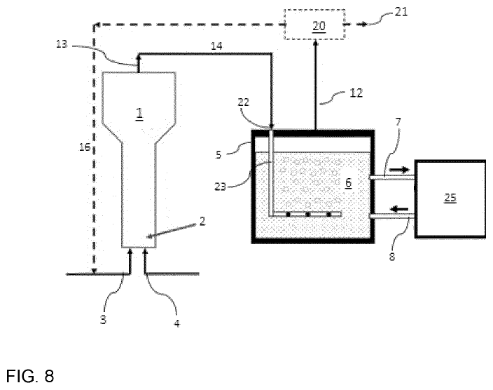

FIG. 8 illustrates the main material flows and operational units in an embodiment of an apparatus suitable for operating the process for producing an aluminium chloride containing feedstock according to the present disclosure. The apparatus comprises a chlorinating reactor 1, comprising an inlet 2 for an aluminium containing feedstock, an inlet 3 for carbonaceous reducing agent, and an inlet for chlorine gas 4. The chlorinating reactor further comprises an outlet 13 for the chlorination product gas stream 14, which product gas stream 14 is passed to an inlet 22 of an absorption unit 5. The absorption unit comprises means 23 for distributing the product gas stream 14 into a molten salt liquid 6 contained in the absorption unit 5. The absorption unit has an outlet for any gaseous components 12, mainly CO₂, that are not absorbed in the molten salt liquid 6. The gas stream 12 may be led to a reactor 20 for conversion of the CO₂ to CO and oxygen gas 21. The CO gas may be returned by line 16 to the chlorination reactor. The absorption unit 5 may be connected to two transfer conduits 7 and 8. The conduit 7 may transfer molten salt liquid enriched with aluminium chloride to an intermediate volume, and the conduit 8 may transfer aluminium chloride lean electrolyte to the absorption unit. Although only one intermediate volume one is shown in the drawing, the intermediate volume 25 may consist of more than one volume, and may be separate for each transfer lines 7 and 8.

### Example

The invention can be illustrated by an example of a possible way to operate the process. The illustrating example is not limiting the invention as there are several other ways to perform the process within the scope of the appended claim set. There is a carbochlorination reactor where the aluminium chloride is produced, an absorption chamber and an electrolysis cell, see FIG. 3. The absorption chamber and the electrolysis cell contain a molten mixture of alkali chlorides, differing mainly in their aluminium chloride concentration and temperature. In this example, the electrolyte in the electrolysis cell consists of 5% AlCl₃, 47.5% NaCl and 47.5% KCl by weight. The electrolyte temperature is 700° C. The composition of the molten salt liquid in the absorption chamber is 75% AlCl₃, 12.5% NaCl and 12.5% KCl by weight. Its temperature is 150° C. Upstream the absorption chamber is the carbochlorination reactor for production of aluminium chloride by reacting Al₂O₃ with CO and Cl₂ (Al₂O₃+3CO+3Cl₂=2AlCl₃+3CO₂). The outgoing stream of this reactor is thus mainly a gaseous mixture of aluminium chloride and CO₂. Its temperature is 700° C. The gas mixture is cooled to a temperature above the condensation point of aluminium chloride, in this example 180° C. The cooled mixture is led into the absorption chamber. Here, the majority of the aluminium chloride is absorbed by the molten salt liquid. To keep the composition of the molten salt liquid in the absorption chamber nearly constant, a stream of electrolyte from the electrolysis cell is also added to the absorption chamber. This stream may be liquid or solid. The net reaction in the absorption chamber is therefore mixing of the 5% aluminium chloride electrolyte stream from the electrolysis cell with nearly pure aluminium chloride in gaseous stream from the carbochlorination reactor, resulting in a molten salt liquid mixture with a composition, in this example, of 75% by weight aluminium chloride. The CO₂ entering the absorption chamber together with the aluminium chloride will leave the absorption chamber mainly unreacted. Therefore, in the absorption chamber there is produced a mass of the molten salt liquid 75% by weight aluminium chloride mixture equal to the sum of the mass of the aluminium chloride absorbed from the gas and the mass of the aluminium chloride lean electrolyte fed from the electrolysis cell. To maintain the level in the absorption chamber and to supply AlCl₃ to the electrolysis cell this mass is returned to the electrolysis cell. Simultaneously, the other electrolyte components (NaCl and KCl) fed to the absorption chamber are returned to the electrolysis cell, thereby maintaining its NaCl and KCl content. The aluminium chloride in the 75% aluminium chloride mixture fed from the absorber is consumed in the electrolysis cell to produce aluminium metal and chlorine gas. The material streams are illustrated in FIG. 4.

The absorption of aluminium chloride is quite exothermic. To prevent overheating the liquid in the container, cooling is required, even in the case when the electrolyte stream into the container has been solidified prior to addition. Cooling can be achieved by installing cooling devices, for example hollow panels or coils internally cooled by water or steam. It is also possible to cool the surfaces of the absorption chamber. The temperature of the container is high enough to give relatively high outgoing temperature of the cooling media, allowing use of the extracted heat for other purposes. At the same time the temperature is sufficiently low to avoid serious material challenges for the container and cooling devices.

This invention greatly simplifies the condensation of aluminium chloride produced by chlorination of alumina. It also eliminates the need for sophisticated feeding devices for solid aluminium chloride to the electrolysis cell that is required if the temperature at the feeding point of aluminium chloride is much higher than the sublimation point of aluminium chloride. Compared to the absorption described in U.S. Pat. No. 4,576,690, where the gaseous mixture is absorbed in the electrolysis cell itself, the present invention has the advantage that the temperature in the separate absorption chamber can be chosen independently of the temperature in the electrolysis cell, which is typically above the melting point of aluminium at 660° C. This allows for much lower temperatures during absorption, leading to the possible use of cheaper materials. It also makes extraction of the heat caused by the exothermic absorption much simpler. It also allows for additional treatment of the gas before it enters the electrolysis cell.

It is desirable that the electrolyte from the absorber that is to be fed to the electrolysis cell is nearly completely free from oxygen. To ensure that the outgoing electrolyte from the absorber is free from oxygen, the atmosphere in the absorber may contain a small amount of a chlorinating agent. Under some conditions, CO₂ may react with aluminium chloride to form CO and alumina: CO₂+AlCl₃=0.5Al₂O₃+CO+1.5Cl₂. This reaction is effectively suppressed if there is a small amount of a chlorinating agent present. The chlorinating agent may be a mixture of CO and Cl₂, phosgene (COCl₂), carbon tetra chloride, CCl₄, carbon and chlorine, or similar.

1. A process for electrolytic production of aluminium from aluminium chloride, in an electrolysis cell unit (9) comprising an electrolyte and at least one anode (17) and at least one cathode (18), wherein the process comprises the following steps,
(a) chlorinating an aluminium containing feedstock by use of chlorine gas and a carbonaceous reducing agent, CO and/or phosgene, forming a product gas stream (14) comprising aluminium chloride gas, and CO₂ gas;
(b) passing all or a fraction of the product gas stream (14) comprising aluminium chloride gas and CO₂ gas from the chlorination step (a) to an absorption unit (5, 35, 75) which comprises a molten salt liquid (6), in which molten salt liquid the aluminium chloride gas is at least partly absorbed forming a molten salt liquid enriched with aluminium chloride, and wherein the CO₂ gas (12) and any other gaseous components that are not absorbed by the molten salt liquid are led out of the absorption unit (5) and optionally processed in one or more separate processing unit(s);
(c) transferring a portion of the molten salt liquid enriched with aluminium chloride from the absorption unit, either directly or indirectly, to the electrolyte in the electrolysis cell unit, wherein aluminium chloride is electrolytically converted to aluminium metal and chlorine gas; and
(d) transferring a portion of aluminium chloride lean electrolyte from the electrolysis cell unit, which has a lower concentration of aluminium chloride than the molten salt liquid, either directly or indirectly, to the absorption unit, thereby replacing some of the molten salt liquid removed from the absorption unit.

2. The process according to claim 1, where the aluminium containing feedstock is an aluminium oxide containing feedstock, where the aluminium oxide containing feedstock is one or more from the group; alumina (Al₂O₃), aluminium oxide ore, or aluminium oxide clay mineral.

3. (canceled)

4. (canceled)

5. The process according to claim 1, wherein the molten salt liquid in the absorption unit is a molten salt mixture comprising aluminium chloride, and one or more salt(s) selected from the group; alkali metal chloride and alkaline earth metal chloride.

6-7. (canceled)

8. The process according to claim 1, wherein the electrolyte in the electrolysis cell unit is a molten salt mixture comprising aluminium chloride, and one or more salt(s) selected from the group; alkali metal chloride and alkaline earth metal chloride, the one or more salt(s) selected from the group; alkali metal chloride and alkaline earth metal chloride being the same as in the molten salt liquid in the absorption unit.

9-11. (canceled)

12. The process according to claim 1, wherein the portion of the molten salt liquid enriched with aluminium chloride is indirectly transferred from the absorption unit to the electrolysis cell unit via one or more intermediate volume(s), and/or the aluminium chloride lean electrolyte is indirectly fed from the electrolysis cell unit to the absorption unit via one or more intermediate volume(s).

13. (canceled)

14. (canceled)

15. The process according to claim 1, wherein the portion of the molten salt liquid enriched with aluminium chloride is directly transferred from the absorption unit to the electrolysis cell unit via one or more fluid passage(s), optionally via one or more intermediate mixing volume(s), and/or the portion of the aluminium chloride lean electrolyte is directly transferred from electrolysis cell unit to the absorption unit via one or more fluid passage(s), optionally via one or more intermediate mixing volume(s).

16. (canceled)

17. (canceled)

18. The process according to claim 12, wherein the one or more intermediate volume(s) involves mixing the portion of aluminium chloride lean electrolyte with a portion of the molten salt liquid enriched with aluminium chloride.

19-22. (canceled)

23. The process according to claim 1, further comprising collecting and passing the CO₂ gas from the chlorinating step (a) and/or the absorption step (b) to a reactor and converting the CO₂ into CO gas and O₂ gas, and feeding the CO gas to the chlorinating step (a).

24. (canceled)

25. The process according to claim 1, further comprising collecting the Cl₂ gas from the electrolysis cell unit (9) and passing the Cl₂ gas to the chlorinating step (a).

26. An apparatus for operating the process according to claim 1, comprising,
a chlorinating reactor vessel (1) comprising a supply of an aluminium containing feedstock (2), a supply of a chlorinating gas (4) and a supply of a reducing agent (3), and an outlet for product gas stream comprising at least aluminium chloride gas, CO₂ gas;
an absorption unit (5, 35, 75) comprising an inlet (22, 32, 72) for receiving all or a fraction of the product gas stream (14) from the chlorinating reactor vessel (1), wherein the absorption unit (5, 35, 75) comprises a molten salt liquid in which gas components of the product gas stream are partly absorbed providing a molten salt liquid enriched with aluminium chloride, and a gas outlet (12, 33, 73) for extraction of CO₂ gas and any gases not absorbed by the molten salt liquid in the absorption unit; and
one or more transfer means (7, 107, 8, 108) arranged between said absorption unit (5, 35, 75) and an electrolysis cell unit (9) configured for direct or indirect transfer of the molten salt liquid enriched with aluminium chloride from the absorption unit (5) to the electrolysis cell unit (9), wherein said aluminium chloride is electrolytically converted to aluminium metal (24) and chlorine gas, and for direct or indirect transfer of aluminium chloride lean electrolyte from the electrolysis cell unit (9) to the absorption unit (5, 35, 75).

27. The apparatus according to claim 26, where the absorption unit (5) is a bubble column or a vessel comprising means for distribution of the product gas stream in the molten salt liquid;
or
a counter-current absorption unit (35) having at least an inlet (36) for aluminium chloride lean electrolyte from the electrolysis cell unit (9) and an outlet (34) for molten salt liquid enriched with aluminium chloride, a means (30) configured to circulate the molten salt liquid (6) in the counter-current absorption unit (35), an inlet (32) for the product gas stream (14), and an outlet (33) for extraction of CO₂ gas and any gases not absorbed by the molten salt liquid, where a flow direction (37) of the product gas stream (14) is configured opposite a flow direction of the molten salt liquid (31);
or
a tray absorption tower (75) having a plurality of absorption trays (76) arranged vertically and in a distance from each other in the absorption tower, comprising an inlet (72) for the product gas stream below a bottom tray and an inlet of aluminium chloride lean electrolyte above a top tray, and furthermore an outlet (73) arranged at the top of the absorption tower for extraction the CO₂ gas and any other gases not absorbed by the molten salt liquid (6), and an outlet (74) for molten salt liquid enriched with aluminium chloride (78) in a lower part of the absorption tower.

28. (canceled)

29. (canceled)

30. The apparatus according to claim 26, where the transfer means (7, 107, 8, 108) configured for indirect transfer of molten salt liquid enriched with aluminium chloride and/or aluminium chloride lean electrolyte comprise one or more intermediate volume(s) (25), configured to mix molten salt liquid enriched with aluminium chloride and aluminium chloride lean electrolyte, and/or to adjust the temperature of the molten salt liquid enriched with aluminium chloride and/or aluminium chloride lean electrolyte, and optionally, the one or more intermediate volume(s) (25) is (are) configured is to partly or fully solidify the molten salt liquid enriched with aluminium chloride or the aluminium chloride lean electrolyte, or a mixture thereof.

31. (canceled)

32. The apparatus according to claim 26, where the transfer means (7, 107, 8 108) configured for direct transfer of molten salt liquid enriched with aluminium chloride and/or aluminium chloride lean electrolyte comprise conduits for fluidly connecting the absorption unit (5, 35, 75) and the electrolysis cell unit (9), optionally via one or more intermediate volume(s) (25) configured to mix molten salt liquid enriched with aluminium chloride and aluminium chloride lean electrolyte, and optionally to adjust the temperature of the obtained mix.

33. (canceled)

34. The apparatus according to claim 26, where the chlorine gas is extracted from the electrolysis cell unit (9) via outlet (11) and returned to the chlorination reactor vessel (1).

35. The apparatus according to claim 26, further comprising means for collecting and passing the CO₂ gas from the chlorination reactor vessel (1) and/or the absorption unit (5, 35, 75), to a reactor (20) in which the CO₂ gas is processed and converted into CO gas and O₂ gas, and further comprising means for feeding the said CO gas to the chlorination reaction vessel (1).

36. (canceled)

37. A process for producing an aluminium chloride containing feedstock for electrolytic production of aluminium from aluminium chloride, in an electrolysis cell with a molten salt electrolyte, the method comprises the following steps;
(a) chlorinating an aluminium containing feedstock by reacting with chlorine gas and a carbonaceous reducing agent, CO and/or phosgene, forming a product gas stream comprising aluminium chloride gas, CO₂ gas and any unreacted reactants and incidental impurities; and
(b) passing all or a fraction of the product gas stream comprising at least aluminium chloride gas and CO₂ gas from the chlorination step (a) to an absorption unit, the absorption unit containing a molten salt liquid, and in which molten salt liquid the aluminium chloride gas is at least partly absorbed and thereby forming a molten salt liquid enriched with aluminium chloride, and wherein the CO₂ gas and any other gaseous components that are not absorbed by the molten salt liquid are led out of the absorption unit and optionally processed in one or more processing unit(s).

38. The process according to claim 37, wherein the aluminium containing feedstock is an aluminium oxide containing feedstock, wherein the aluminium oxide containing feedstock is one or more selected from the group comprising; alumina (Al₂O₃), aluminium oxide ore, or aluminium oxide clay mineral.

39. (canceled)

40. (canceled)

41. The process according to claim 37, wherein the molten salt liquid in the absorption unit is a molten salt mixture comprising aluminium chloride, and one or more salt(s) selected from the group; alkali metal chloride and alkaline earth metal chloride; and incidental impurities.

42-49. (canceled)

50. The process according to claim 37, wherein the process further comprises collecting and passing the CO₂ gas from the chlorinating step (a) and/or the absorption step (b) to a reactor wherein the CO₂ is decomposed producing CO gas and feeding the CO gas to the chlorinating step (a).

51. An apparatus for operating the process for producing an aluminium chloride containing feedstock for electrolytic production of aluminium from aluminium chloride, in an electrolysis cell with a molten salt electrolyte, the apparatus comprising
a chlorinating reactor vessel (1) comprising a supply of an aluminium containing feedstock (2), a supply of a chlorinating gas (4) and a supply of a reducing agent (3), and an outlet (13) for product gas stream (14) comprising at least aluminium chloride gas, CO₂ gas;
an absorption unit (5, 35, 75) comprising an inlet (22) for receiving all or a fraction of the product gas stream (14) from the chlorinating reactor vessel (1), the absorption unit (5, 35, 75) containing a molten salt liquid (6) in which gas components of the product gas stream are partly absorbed and thereby forming a molten salt liquid enriched with aluminium chloride, and a gas outlet (12, 33, 73) for extraction of CO₂ gas and any gases not absorbed by the molten salt liquid in the absorption unit (5, 35, 7); and
means (7, 8) for transferring the molten salt liquid enriched with aluminium chloride to an electrolysis cell via one or more intermediate volumes (25).

52. The apparatus according to claim 51, wherein the absorption unit is a bubble column or a vessel comprising means (23) for distribution of the product gas stream in the molten salt liquid (6);
or
a counter-current absorption unit comprising at least an inlet (36) for aluminium chloride lean molten salt electrolyte and an outlet (34) for molten salt liquid enriched with aluminium chloride, a means (30) configured to circulate the molten salt liquid (6) in the counter-current absorption unit, an inlet (32) for the product gas stream, and an outlet (33) for extraction of CO₂ gas and any gases which are not absorbed by the molten salt liquid, wherein the flow direction (37) of the product gas stream is configured opposite a flow direction (31) of the molten salt liquid;
or
a tray absorption tower (75) having a plurality of absorption trays (76) arranged vertically and in a distance from each other in the absorption tower, comprising an inlet (72) for the product gas stream below a bottom tray and an inlet of aluminium chloride lean electrolyte above a top tray, and furthermore an outlet (73) arranged at the top of the absorption tower for extraction the CO₂ gas and any other gases not absorbed by the molten salt liquid (6), and an outlet (74) for molten salt liquid enriched with aluminium chloride (78) in a lower part of the absorption tower.

53. (canceled)

54. (canceled)

55. The apparatus according to claim 51, further comprising means for collecting and passing the CO₂ gas from the chlorination reactor vessel and/or the absorption unit (5, 35, 75) to a reactor (20) in which reactor the CO₂ gas is processed and converted into CO gas, which CO gas is recycled to the chlorination reactor vessel (1) via a transfer line (16).
